(19) United States
(12) Patent Application Publication
(10) Pub. No.: US 2026/0264203 A1
(43) Pub. Date: Sep. 10, 2026

(54) SYSTEMS AND METHODS FOR INSTALLING AND REMOVING BUSHING ASSEMBLIES

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 19/548,764

(22) Filed: Feb. 24, 2026

Related U.S. Application Data
(60) Provisional application No. 63/768,120, filed on Mar. 6, 2025.

(51) Int. Cl. B25B 27/28; B25B 27/00

(52) U.S. Cl. CPC B25B 27/28; B25B 27/0035

(57) ABSTRACT

A bushing displacement system comprising a housing defining a drive axis, at least one shoe member and at least one connecting assembly. The at least one connecting assembly is configured to support the at least one shoe member on the housing such that the at least one shoe member moves relative to the housing both along the drive axis and radially relative to the drive axis.

### RELATED APPLICATIONS

This application (Attorney’s Ref. No. P220746) claims benefit of U.S. Provisional Application Serial No. 63/768,120 filed Mar. 6, 2025, the contents of which are incorporated herein by reference.

### TECHNICAL FIELD

The present invention relates to the installation and/or removal of bushing assemblies and, in particular, to the installation and/or removal of bushing assemblies for vehicles such as trucks and automobiles.

### SUMMARY

The present invention may be embodied as a bushing displacement system comprising a housing defining a drive axis, at least one shoe member and at least one connecting assembly. The at least one connecting assembly is configured to support the at least one shoe member on the housing such that the at least one shoe member moves relative to the housing both along the drive axis and radially relative to the drive axis.

The present invention may be embodied as a method for displacing a bushing member relative to a structure. A housing is provided, the housing defining a drive axis. At least one shoe member is provided. At least one connecting assembly is provided. The at least one connecting assembly is configured to support the at least one shoe member on the housing such that the at least one shoe member moves relative to the housing both along the drive axis and radially relative to the drive axis.

The present invention may further be embodied as a bushing displacement system for displacing a bushing member relative to a structure, the bushing displacement system comprising a housing, at least one shoe member, and at least one connecting assembly. The housing defines a drive axis. The at least one connecting assembly is configured to support the at least one shoe member on the housing. When a force is applied to the housing along the drive axis, the at least one shoe member engages at least a portion of the bushing member and at least a potion of the housing such that the at least one shoe member moves relative to the housing both along the drive axis and radially relative to the drive axis.

### BRIEF DESCRIPTION OF THE DRAWINGS

FIG. 1 is a top perspective view of a first example bushing displacement system constructed in accordance with, and embodying, the principles of the present invention;

FIG. 2 is a bottom top perspective view of the first example bushing displacement system;

FIG. 3 is a bottom plan view of the first example bushing displacement system;

FIG. 4 is an exploded perspective view of the first example bushing displacement system;

FIG. 5 is an exploded section view of the first example bushing displacement system;

FIG. 6 is a section view taken along lines 6-6 in FIG. 3;

FIG. 7 is a section view taken along lines 7-7 in FIG. 3;

FIG. 8 is a section view illustrating the first example bushing displacement system in a pre-displacement configuration with respect to a bushing assembly; and

FIG. 9 is a section view illustrating the first example bushing displacement system in a displacement configuration with respect to the bushing assembly.

### DETAILED DESCRIPTION

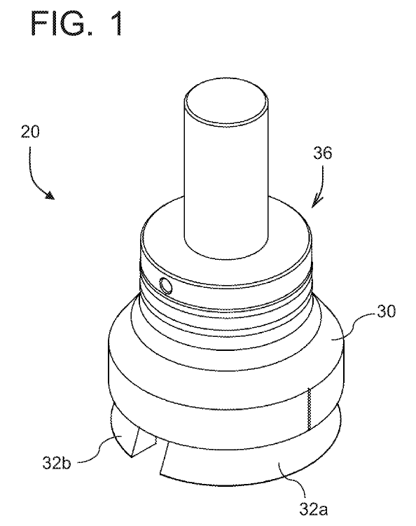

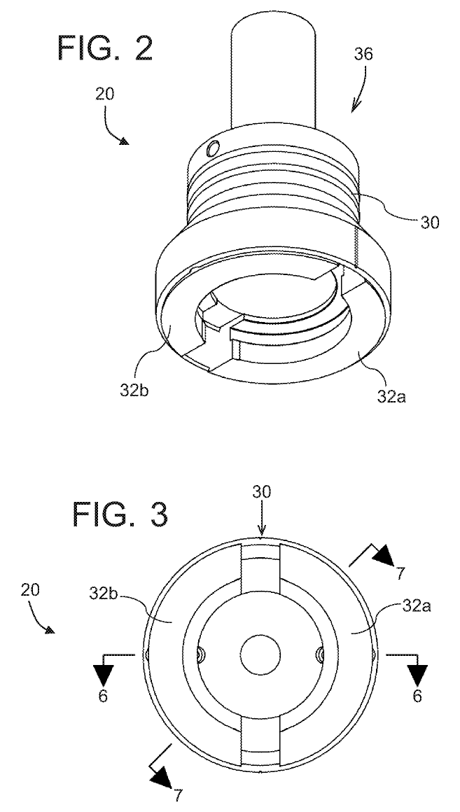

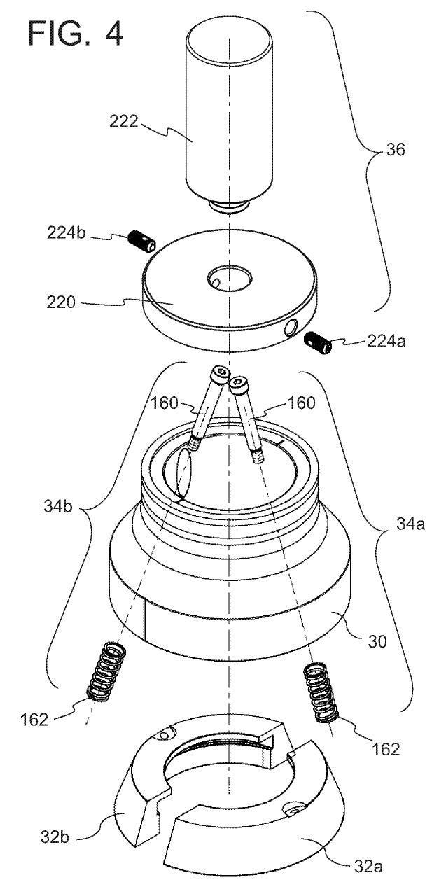

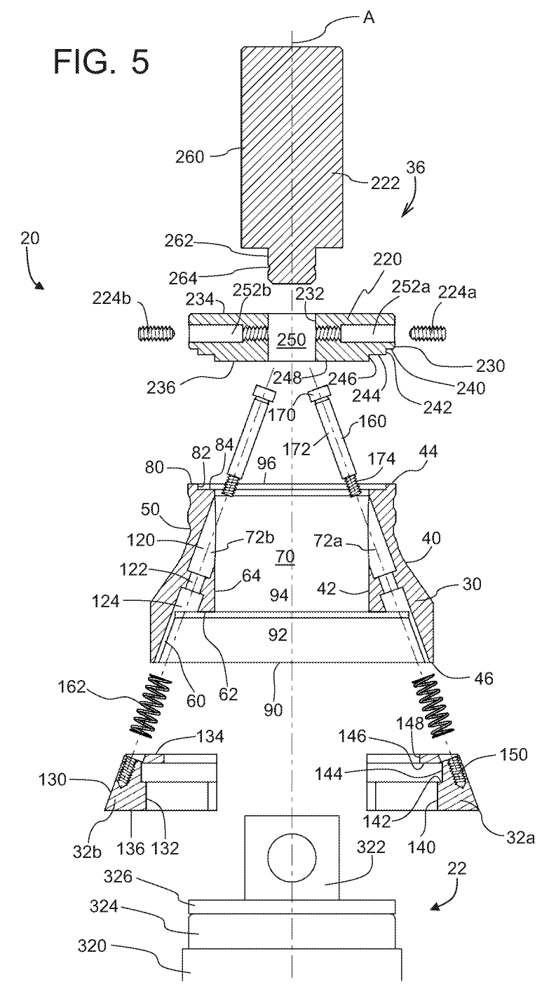

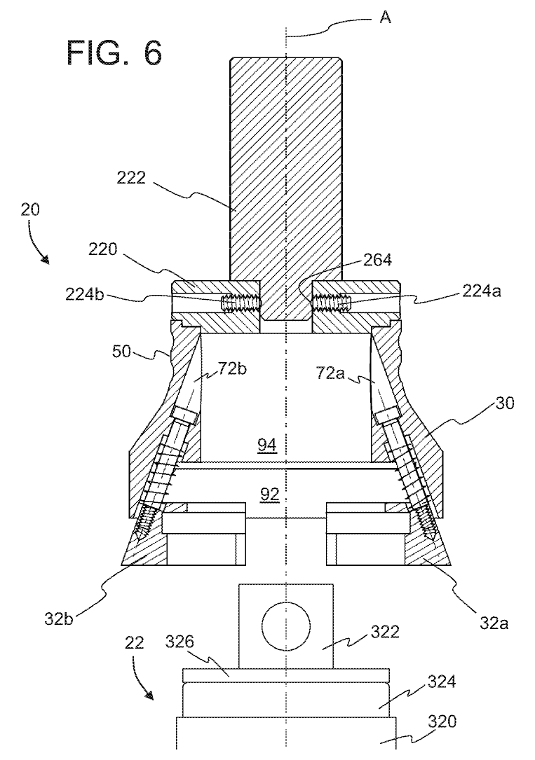

Referring initially to FIGS. 1-4, depicted therein is a first example bushing displacement system 20 constructed in accordance with, and embodying, the principles of the present invention. The first example bushing displacement system 20 is configured to engage an example bushing assembly 22, a portion of which is depicted in FIGS. 5-9. The example bushing assembly 22 is or may be conventional and will be described herein only to that extent helpful to a complete understanding of the construction and operation of the first example bushing displacement system 20.

The first example bushing displacement system 20 comprises a housing member 30, first and second shoe members 32a and 32b, first and second connecting assemblies 34a and 34b, and a cap assembly 36.

The example housing member 30 defines a housing outer surface 40, a housing inner surface 42, a housing first end surface 44, and a housing second end surface 46.

Annular grooves 50 may be formed in the example housing outer surface 40 to facilitate handling of the housing member 30 and the first example bushing displacement system 20.

The example housing inner surface 42 defines a housing inner surface first portion 60, a housing inner surface second portion 62, and a housing inner surface third portion 64. The example housing member 30 further defines an interior chamber 70 and first and second connecting openings 72a and 72b. A drive axis A extends through the interior chamber 70. The example housing inner surface first portion 60 is substantially frustoconical and extends at an angle relative to and is substantially coaxially aligned with the drive axis A. The example housing inner surface second portion 62 is substantially annular and is substantially perpendicular to and coaxially aligned with the drive axis A. The example housing inner surface third portion 64 is substantially cylindrical and is coaxially aligned with the drive axis A.

The housing first end surface 44 defines a housing first end surface first portion 80, a housing first end surface second portion 82, and a housing first end surface third portion 84. The housing first end surface first portion 80 is annular and coaxially aligned with the drive axis A. The housing first end surface second portion 82 is substantially cylindrical and is coaxially aligned with the drive axis A. The housing first end surface third portion 84 is annular and coaxially aligned with the drive axis A.

The example interior chamber 70 defines a shoe opening 90, a shoe portion 92, a cap portion 94, and a cap opening 96. The housing inner surface first portion 60 and housing inner surface second portion 62 define the shoe portion 92. The housing inner surface first portion 60 extends around and at least partly defines the shoe opening 90. The example housing inner surface third portion 64 extends around and at least partly defines the cap opening 96. The example connecting openings 72a and 72b each define a first end portion 120, an intermediate portion 122, and a second end portion 124. Diameters of the example first and second end portions 120 and 124 are substantially the same and larger than a diameter of the intermediate portion 122. The example first end portions 120 are in communication with the cap portion 94 of the interior chamber 70, and the example second end portions 124 are in communication with the shoe portion 92 of the interior chamber 70.

The example first and second shoe members 32a and 32b are identical and each define a shoe outer surface 130, a shoe inner surface 132, a shoe first end surface 134, and a shoe second end surface 136. The example shoe outer surface 130 is at least a portion of a substantially frustoconical shape and extends at an angle relative to and is substantially coaxially aligned with the drive axis A. The example shoe outer surfaces 130 are sized and dimensioned to engage the housing inner surface first portion 60 as discussed below. The example shoe inner surfaces 132 each define a first shoe inner surface portion 140, a second shoe inner surface portion 142, a third shoe inner surface portion 144, a fourth shoe inner surface portion 146, and a fifth shoe inner surface portion 148. The first shoe inner surface first portion 140 extends along a portion of a first arc defining a first arc radius. The shoe inner surface second portion 142 is annular. The shoe inner surface third portion 144 extends along a portion of a second arc defining a second arc radius. The shoe inner surface fourth portion 146 is annular. The shoe inner surface fifth portion 148 extends along a portion of a third arc defining a third arc radius. In the example shoe members 30, the second arc radius is greater than the first arc radius, and the first arc radius is greater than the third arc radius. The shoe first end surface 134 is formed by a portion of a first annulus, and the shoe second end surface 136 is formed by a portion of a second annulus. A threaded cavity 150 is formed in the shoe first end surface 134.

The example first and second connecting assemblies 34a and 34b are the same and each comprises a bolt 160 and a spring 162. The example bolts 160 define a head portion 170, a shaft portion 172, and a threaded portion 174. The example head portion 170 is sized and dimensioned to be received by the first end portion 120 of the example connecting openings 72a and 72b. The example shaft portion 172 is sized and dimensioned to be received by the intermediate 122 of the example connecting openings 72a and 72b. The example threaded portion 174 is adapted to be threadingly received by the threaded cavities 150 in the shoe members 32a and 32b. The example springs 162 are adapted to be received in the second end portion 124 of the example connecting openings 72a and 72b around the shaft portion 172 of the bolts 160.

The example cap assembly 36 comprises a cap plate 220, a cap rod 222, and first and second set screws 224a and 224b. The example cap plate 220 defines a cap plate exterior surface 230, a cap plate interior surface 232, a cap plate first end surface 234, and a cap plate second end surface 236. The cap plate exterior surface 230 and cap plate interior surface 232 are substantially cylindrical. The example cap plate first end surface 234 is annular. The example cap plate second end surface 236 defines a cap plate second end surface first portion 240, a cap plate second end surface second portion 242, a cap plate second end surface third portion 244, cap plate second end surface fourth portion 246, and a cap plate second end surface fifth portion 248. The cap plate second end surface first portion 240, the cap plate second end surface third portion 244, and the cap plate second end surface fifth portion 248 are annular. The cap plate second end surface second portion 242 and cap plate second end surface third portion 244 are cylindrical.

The cap plate interior surface 232 defines a cap plate rod opening 250, and first and second cap plate lateral openings 252a and 252b are arranged to extend from the cap plate exterior surface 230 to the cap plate interior surface 232. The example cap rod 222 comprises a main portion 260 and a connecting portion 262, with a diameter of the example connecting portion 262 being smaller than a diameter of the example main portion 260 to define an annular rod shoulder surface 264. The example set screws 224a and 224b are adapted to be threaded into at least a portion of the cap plate lateral openings 252a and 252b, respectively, such that the cap rod 222 may be detachably attached to the cap plate 220.

The first example bushing displacement system 20 is assembled as follows. Each spring 162 is arranged within a corresponding second end portion 124 of one of the example connecting openings 72a and 72b. Each of the bolts 160 is then arranged such that the threaded portion 174 thereof extends through the first end portion 120 and the intermediate portion 122 of one of the connecting openings 72a and 72b. Axial rotation of the bolts 160 causes the threaded portions 174 thereof to engage one of the threaded cavities 150 in the shoe members 32a and 32b. At this point, the shoe members 32a and 32b are detachably attached to the housing member 30 such that the shoe outer surfaces 130 are in contact with the housing inner surface first portion 60 but are capable of moving relative to the housing member 30 along the drive axis A.

Next, the cap assembly 36 is formed by arranging the connecting portion 262 of the cap rod 222 within the cap plate rod opening 250, and the set screws 224a and 224b are threaded into the cap plate lateral openings 252a and 252b to engage the connecting portion 262 and secure the cap rod 222 to the cap plate 220.

The cap assembly 36 is next arranged such that the cap plate cap plate second end surface 236 engages the housing first end surface 44. In particular, the surface portions of the housing first end surface 44 are configured to mate with the surface portions of the cap plate second end surface 236 to allow forces on the cap assembly 36 along the drive axis A are securely transferred to the housing 30.

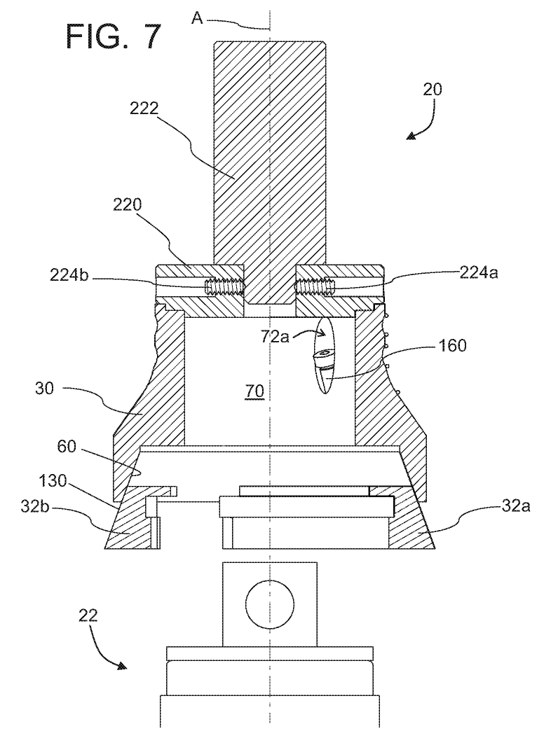

As shown in FIGS. 7-9, the first example bushing displacement system 20 is arranged such that shoe members 32a and 32b engage the bushing assembly 22 to support the first example bushing displacement system 20 on the bushing assembly 22 such that the drive axis A is aligned with a longitudinal axis of the bushing assembly 22. In particular, the example bushing assembly 22 comprises a bushing housing 320, a bushing rod 322, bushing packing material 324, and a bushing plate 326. The bushing plate 326 is annular and arranged around the bushing rod 322 on an upper edge of the bushing packing material 324. The bushing packing material 324 is arranged between the bushing housing 320 and the bushing plate 326.

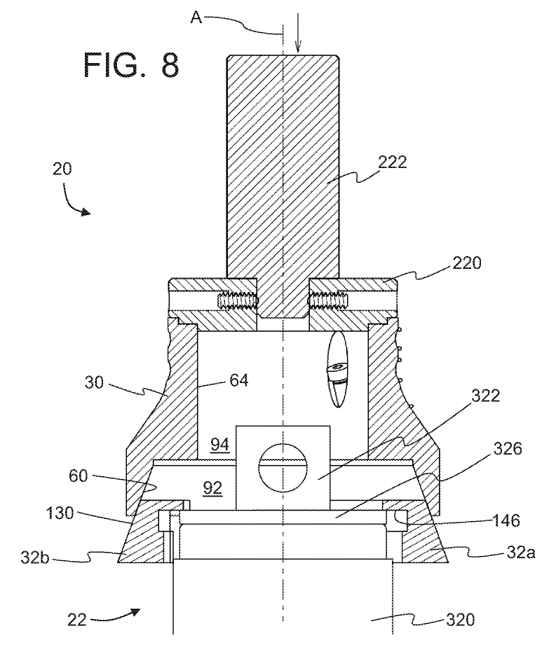

When the bushing displacement system 20 is supported by the bushing assembly 22, the bushing rod 322 extends through the shoe members 32a and 32b and at least partially into the interior chamber 70. A portion of the bushing rod 322 may extend into the cap portion 94. The fourth shoe inner surface portion 146 engages at least a portion of the bushing plate 326 and the shoe inner surface 132 is sized and dimensioned so the bushing plate 126 and the bushing packing material 324 can be arranged within each shoe inner surface 132, as perhaps best illustrated in FIGS. 8.

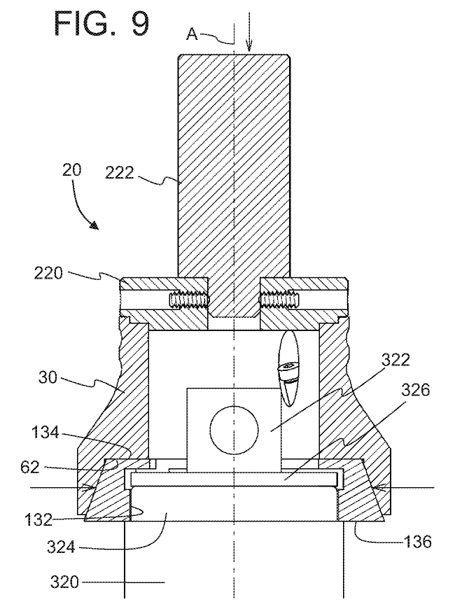

With the first example bushing displacement system 20 supported by the bushing assembly 22, continued displacement of the bushing displacement system 20 (by application of external force) towards the bushing assembly 22 causes the housing member 30 to act on the shoe members 32a and 32b. When force is applied to the housing member 30 through the cap assembly 36, the shoe outer surfaces 130 engage the housing inner surface portion 60 such that the shoe members 32a and 32b move both along the drive axis A and laterally towards each other in a direction substantially perpendicular to the drive axis A. The movement of the shoe members 32a and 32b is both along the drive axis A and radial relative to the drive axis A. The springs 162 resiliently deform within the second end portion 124 as the shoe members 32a and 32b are displaced relative to the housing member 30. When the force is removed, the springs 162 undeform and the shoe members 32a and 32b move both along the drive axis A and radially outward relative to the drive axis A. The shoe members 32a and 32b may be displaced and the springs 162 may be compressed until the inner surface second portion 62 of the housing member 30 engages the shoe first end surface 134 of the shoe members 32a and 32b, as shown in FIG. 9. As the bushing displacement system 20 displaces the bushing plate 326 bushing rod 322, and bushing packing material 324, relative to the bushing housing 322, the shoe inner surfaces 132 may engage at least a portion of the bushing packing material 324. The shoe members 32a and 32b engage the bushing plate 326 and the bushing displacement system 20 continues to move along the drive axis until the bushing assembly 22 is in a desired orientation. Further displacement of the first example bushing displacement system 20 acts on the bushing rod 322 and/or the bushing plate 326 to displace the bushing rod 322, bushing plate 326, and bushing packing material 324 relative to the bushing housing 320.

What is claimed is:

1. A bushing displacement system comprising:
a housing defining a drive axis;
at least one shoe member; and
at least one connecting assembly; wherein
the at least one connecting assembly is configured to support the at least one shoe member on the housing such that the at least one shoe member moves relative to the housing both along the drive axis and radially relative to the drive axis.

2. The bushing displacement system of claim 1, further comprising a cap assembly configured to engage the housing.

3. The bushing displacement system of claim 2, in which the cap assembly comprises a cap plate configured to engage the housing and a cap rod configured to engage the cap plate.

4. The bushing displacement system of claim 1, in which the at least one connecting assembly comprises a resilient member and a bolt member.

5. The bushing displacement system of claim 1, in which:
the housing defines an inner surface first portion; and
the at least one shoe member defines an outer surface portion; wherein
the outer surface portion engages the inner surface first portion to cause movement of the at least one shoe member relative to the housing.

6. The bushing displacement system of claim 5, in which:
the inner surface first portion is angled relative to the drive axis; and
the outer surface portion is angled relative to the drive axis and configured to substantially align with the inner surface first portion.

7. The bushing assembly of claim 1, comprising first and second shoe members.

8. The bushing assembly of claim 7, comprising first and second connecting assemblies configured to support the first and second shoe members, respectively, on the housing.

9. A method for displacing a bushing member relative to a structure, the method comprising the steps of:
providing a housing defining a drive axis;
providing at least one shoe member; and
providing at least one connecting assembly; wherein
configuring the at least one connecting assembly to support the at least one shoe member on the housing such that the at least one shoe member moves relative to the housing both along the drive axis and radially relative to the drive axis.

10. The method of claim 9, further comprising:
providing a cap assembly configured to engage the housing.

11. The method of claim 10, in which providing the cap assembly comprises:
providing a cap plate and a cap rod;
configuring the cap plate to engage the housing; and
configuring the cap rod to engage the cap plate.

12. The method of claim 9, in which providing the at least one connecting assembly comprises providing a resilient member and a bolt member.

13. The method of claim 9, further comprising
configuring the housing to define an inner surface first portion;
configuring the at least one shoe member to define an outer surface portion; wherein
engaging the inner surface first portion with the outer surface portion to cause movement of the at least one shoe member relative to the housing.

14. The method of claim 13, further comprising:
arranging the inner surface first portion at angled relative to the drive axis;
arranging the outer surface portion at an relative to the drive axis; and
configuring the outer surface portion to substantially align with the inner surface first portion.

15. The bushing assembly of claim 9, further comprising providing first and second shoe members.

16. The bushing assembly of claim 15, further comprising
providing first and second connecting assemblies;
configuring the first connecting assembly to support the first shoe member on the housing; and
configuring the second connecting assembly to support the second shoe member on the housing.

17. A bushing displacement system for displacing a bushing member relative to a structure, the bushing displacement system comprising:
a housing defining a drive axis;
at least one shoe member; and
at least one connecting assembly; wherein
the at least one connecting assembly is configured to support the at least one shoe member on the housing; and
when a force is applied to the housing along the drive axis, the at least one shoe member engages at least a portion of the bushing member and at least a potion of the housing such that the at least one shoe member moves relative to the housing both along the drive axis and radially relative to the drive axis.

18. The bushing displacement system of claim 17, further comprising a cap assembly configured to engage the housing.

19. The bushing displacement system of claim 17, in which the at least one connecting assembly comprises a resilient member and a bolt member.

20. The bushing displacement system of claim 17, in which:
the housing defines an inner surface angled first portion; and
the at least one shoe member defines an outer surface angled portion; wherein
the outer surface angled portion engages the inner surface angled first portion to cause movement of the at least one shoe member relative to the housing.
